(19) United States
(12) Patent Application Publication
(10) Pub. No.: US 2013/0335287 A1
(43) Pub. Date: Dec. 19, 2013

(54) HAC COMPATIBLE ANTENNA STRUCTURE

(71) Applicant: NING-FENG ZANG, Shenzhen City (CN)

(72) Inventor: NING-FENG ZANG, Shenzhen City (CN)

(21) Appl. No.: 13/662,875

(22) Filed: Oct. 29, 2012

(30) Foreign Application Priority Data
Jun. 18, 2012 (CN) 201210200774X

(51) Int. Cl. H01Q 1/52

(52) U.S. Cl. 343/841

(57) ABSTRACT

An antenna structure includes an antenna and a radiation blocking member. The antenna includes a main radiating body, a ground end and a feed end. The main radiating body comprises a first radiating portion, a second radiating portion, and a third radiating portion interconnected together. The first radiating portion defines an opening. The ground end and the feed end are extended from the main radiating body. The radiation blocking member is positioned at one side of the antenna and aligned with the opening to block a portion of signal radiation of the antenna.

### BACKGROUND

1. Technical Field

The disclosure generally relates to antenna structures, and particularly to a hearing aid compatibility (HAC) compatible antenna module which has a radiation blocking member to reduce EMI (electromagnetic interference) to listening equipments such as hearing aids.

2. Description of Related Art

When a wireless communication device is close to a hearing aid while communicating with other devices, electromagnetic radiation of the wireless communication may cause interference with the hearing aid.

With respect to the above-mentioned problem of concomitant use between the wireless communication device and the hearing aid, the standardization of the United States group American National Standards Institute (ANSI) established compatibility between the wireless communication device and the hearing aid under “ANSI C63.19”. The ANSI C63.19 standards regularize the hearing aid compatibility test as follows:

A test probe is used to measure electromagnetic fields intensity of 5*5 cm about 15 mm above a sound hole of the wireless communication device. A test plane is divided into nine girds. Peak electromagnetic field intensity of the nine girds is used to define HAC levels. The HAC levels are defined as levels M1, M2, M3, and M4 having 5 db value difference among them. The characteristics of HAC are better when the level is higher. However, most wireless communication devices are difficult to achieve higher levels, and have larger interference to the hearing aids.

Therefore, there is room for improvement within the art.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the disclosure.

FIG. 1 is a schematic view of an antenna structure, according to an exemplary embodiment of the disclosure.

FIGS. 2 and 3 are exemplary HAC test graphs of an antenna of FIG. 1 without an radiation blocking member.

FIGS. 4 and 5 are exemplary HAC test graphs of the antenna of FIG. 1 with the radiation blocking member.

FIG. 6 is an exemplary test graph obtained from the antenna of FIG. 1 without the radiation blocking member, disclosing return loss varying with frequency.

FIG. 7 is an exemplary test graph obtained from the antenna of FIG. 1 with the radiation blocking member, disclosing return loss varying with frequency.

### DETAILED DESCRIPTION

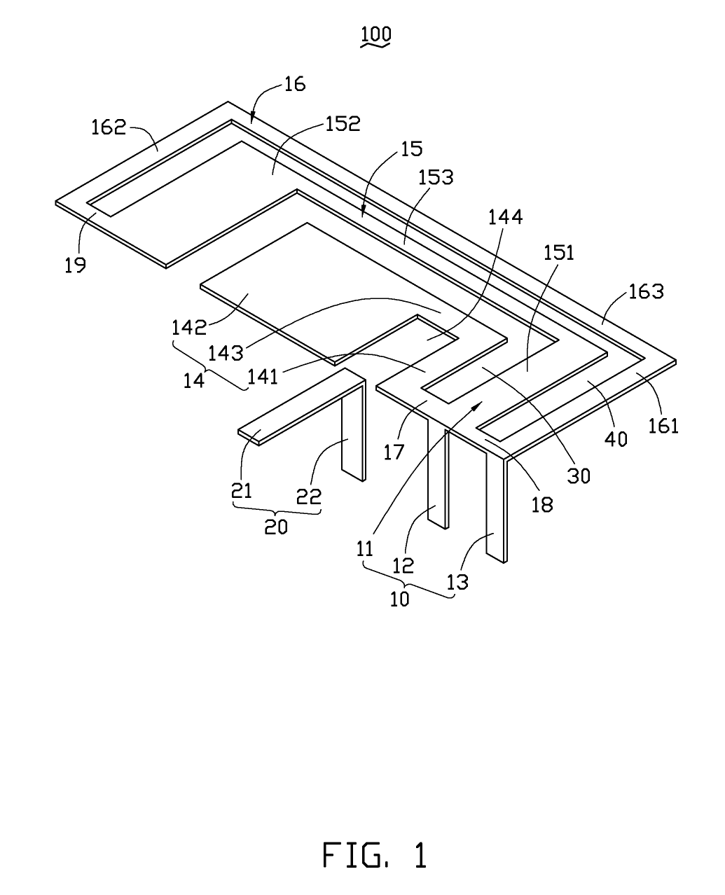

FIG. 1 is a schematic view of an antenna structure 100, according to an exemplary embodiment of the disclosure. The antenna structure 100 used in a wireless communication device includes an antenna 10 and a radiation blocking member 20 positioned at one side of the antenna 10. The radiation blocking member 20 blocks a portion of radiation of the antenna 10 to reduce interference from the antenna 10 to a hearing aid.

The antenna 10 includes a main radiating body 11, a feed end 12, a ground end 13. The feed end 12 and the ground end 13 are positioned at one side of the main radiating body 11.

The main radiating body 11 is a curved sheet including a substantially U-shaped first radiating portion 14, a second radiating portion 15, a third radiating portion 16, a first combining portion 17, a second combining portion 18 and a third combining portion 19.

The first radiating portion 14 includes a first end portion 141, an opposite second end portion 142, and a first connecting portion 143. A length of the first end portion 141 is substantially the same as a length of the second end portion 142. A width of the first end portion 141 is slightly narrower than a width of the second end portion 142. Two opposite ends of the first connecting portion 143 are respectively connected to the first end portion 141 and the second end portion 142. The first connecting portion 143 forms an opening 144 with the first end portion 141 and the second end portion 142.

The structure of the second radiating portion 15 is substantially similar to that of the first radiating portion 14. The second radiating portion 15 includes a third end portion 151, an opposite fourth end portion 152, and a second connecting portion 153. A length of the third end portion 151 is substantially the same as a length of the fourth end portion 152. A width of the third end portion 151 is slightly narrower than a width of the four end portion 152. Two opposite ends of the second connecting portion 153 are respectively connected to the third end portion 151 and the fourth end portion 152, and they form the substantially U-shaped second radiating portion 15. The second radiating portion 15 is positioned at one side of the first radiating portion 14 with the third end portion 151, the fourth end portion 152, and the second connecting portion 153 are respectively parallel to the first end portion 141, the second end portion 142, and the first connecting portion 151. The second radiating portion 15 is spaced from the first radiating portion 14. A substantially U-shaped first slot 30 is formed between the second radiating portion 15 and the first radiating portion 14.

The structure of the third radiating portion 16 is substantially similar to those of the first radiating portion 14 and the second radiating portion 15. The third radiating portion 16 includes a fifth end portion 161, an opposite sixth end portion 162, and a third connecting portion 163. A length and a width of the fifth end portion 161 are substantially the same as a length and a width of the sixth end portion 151. Two opposite ends of the third connecting portion 163 are respectively connected to the fifth end portion 161 and the sixth end portion 162, and they form the substantially U-shaped third radiating portion 16. The third radiating portion 16 is positioned at one side of the second radiating portion 15 with the fifth end portion 161, the sixth end portion 162, and the third connecting portion 163 are respectively parallel to the third end portion 151, the fourth end portion 152, and the second connecting portion 153. The third radiating portion 16 is spaced from the second radiating portion 15. A substantially U-shaped second slot 40 is formed between the third radiating portion 16 and the second radiating portion 15.

The first, second and third combining portions 17, 18, 19 are substantially strip-shaped. Two opposite ends of first combining portion 17 are respectively connected to the first end portion 141 and the third end portion 151 to interconnect the first radiating portion 14 and the second radiating portion 15. Two opposite ends of second combining portion 18 are respectively connected to the third end portion 151 and the fifth end portion 161 and two opposite ends of third combining portion 19 are respectively connected to the fourth end portion 152 and the sixth end portion 162. The second radiating portion 15 and the third radiating portion 16 are interconnected by the second combining portion 18 and the third combing portion 19.

The feed end 12 and the ground end 13 are substantially strip-shaped. The feed end 12 and the ground end 13 are positioned in a plane perpendicular to the first, second, and third radiating portions 14, 15, and 16. The feed end 12 is extended from an end of the third end portion 151. The ground end is extended from an end of the fifth end portion 161.

The radiation blocking member 20 is a substantially L-shaped sheet including a first curved portion 21 and a second curved portion 22, perpendicularly connected to the first curved portion 21. The radiation blocking member 20 is positioned at one side of the antenna 10 aligning with the opening 144. The first curved portion 21 is coplanar with the first radiating portion 14. The second curved portion 22 is coplanar with the ground end 13 and the feed end 12. The radiation blocking member 20 may be positioned in the wireless communication device adjacent to an audio receiver. When the hearing aid is inserted into the wireless communication device, the radiation blocking member 20 blocks the portion radiation of the antenna 10 toward the audio receiver.

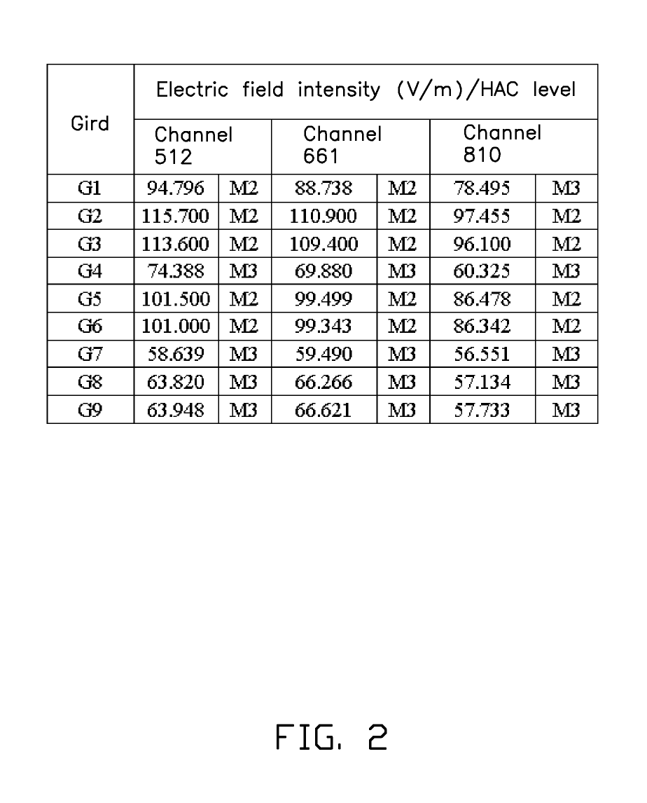

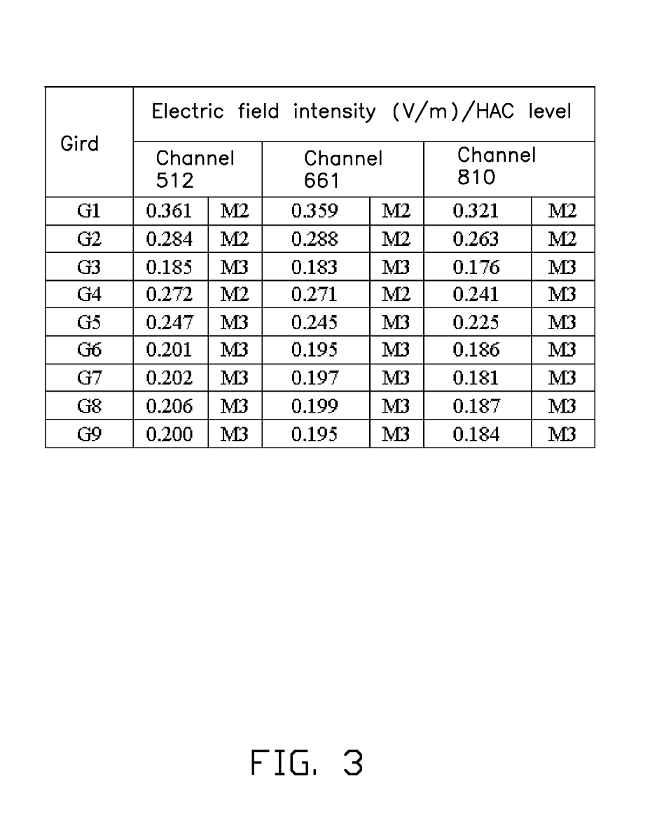

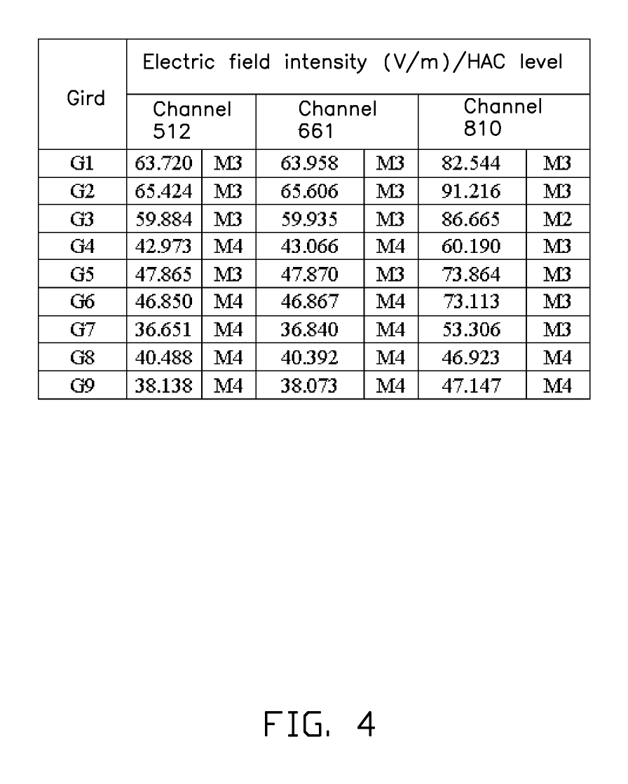

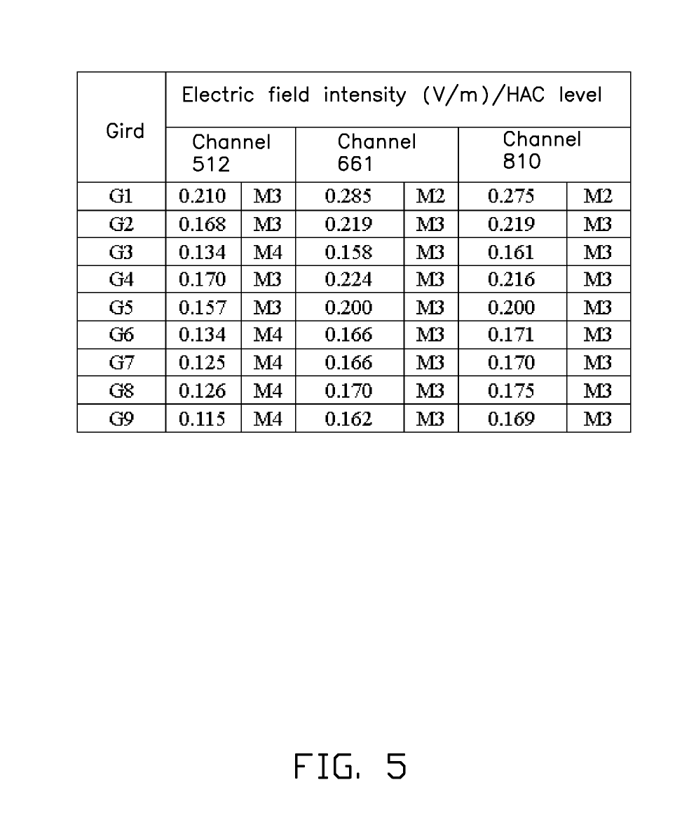

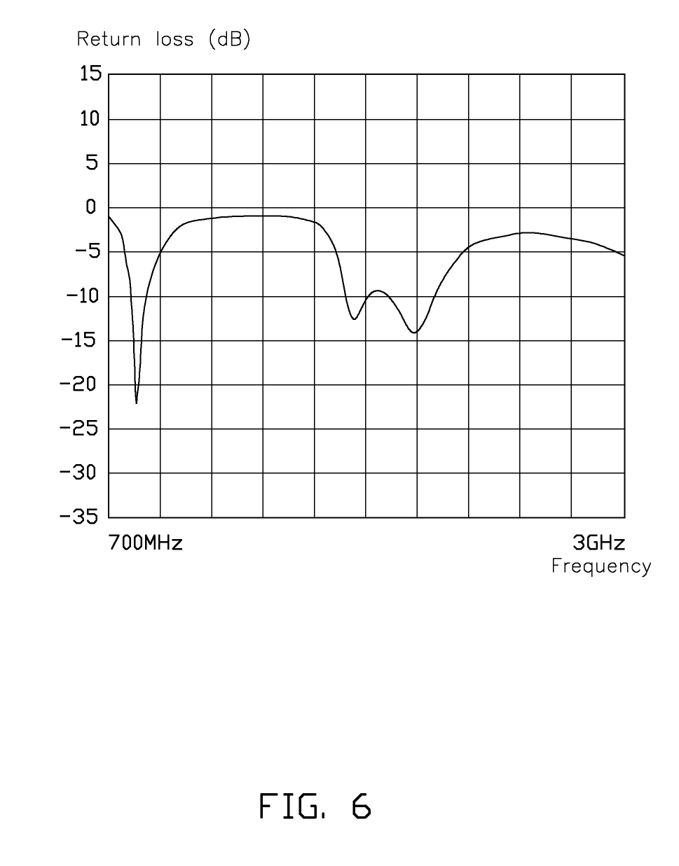

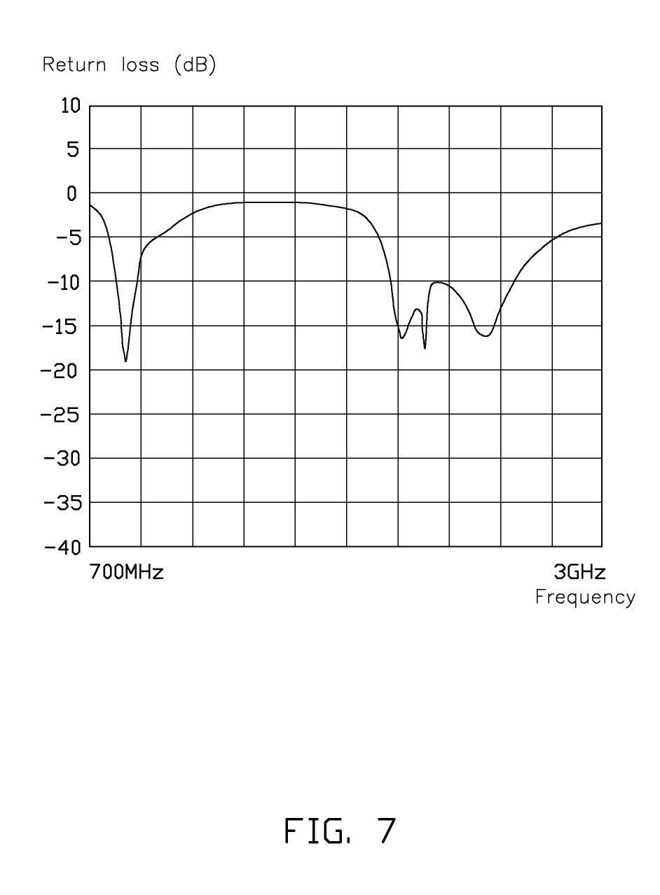

Referring to FIGS. 2-5, electromagnetic field intensity of the antenna structure 100 with the radiation blocking member 20 is weakened; and the HAC level is increased with the characteristics of HAC improved. Meanwhile, referring to FIGS. 6 and 7, although the radiation blocking member 20 blocks the portion of the radiation of the antenna 10. The radiation performance of the antenna structure 100 still can satisfy communication requirement of GMS frequency band.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An antenna structure, comprising:
an antenna, the antenna comprising:
a main radiating body; the main radiating body comprising a first radiating portion, a second radiating portion, and a third radiating portion interconnected together; and the first radiating portion defining an opening;
a ground end and a feed end; and the ground end and the feed end extended from the main radiating body; and
a radiation blocking member positioned at one side of the antenna aligned with the opening, to block a portion of signal radiation of the antenna.

2. The antenna structure of claim 1, wherein the radiation blocking member comprises a first curved portion, and a second curved portion, perpendicularly connected to the first curved portion; the first curved portion aligns with the opening, and is coplanar with the first radiating portion; and the second curved portion is coplanar with the ground end and the feed end and parallel to the ground end and the feed end.

3. The antenna structure of claim 1, wherein the first radiating portion is substantially U-shaped and comprises a first end portion, a opposite second end portion, a first connecting portion; and two opposite ends of the first connecting portion are respectively connected the first end portion and the second end portion, the first end portion, the first connecting portion and the second end portion define the opening.

4. The antenna structure of claim 3, wherein the second radiating portion is positioned at one side of the first radiating portion, and forms a first slot with the first radiating portion.

5. The antenna structure of claim 4, wherein the second radiating portion substantially U-shaped and comprises a third end portion, a fourth end portion, and a second connecting portion; two opposite ends of the second connecting portion are respectively connected the third end portion and the fourth end portion; and the first slot is substantially U-shaped.

6. The antenna structure of claim 5, wherein the third radiating portion is positioned at one side of the second radiating portion, and forms a second slot with the second radiating portion.

7. The antenna structure of claim 6, wherein the third radiating portion substantially U-shaped and comprises a fifth end portion, a sixth end portion, and a third connecting portion; and two opposite ends of the third connecting portion are respectively connected the fifth end portion and the sixth end portion; and the second slot is substantially U-shaped.

8. The antenna structure of claim 5, further comprise a first combining portion, two opposite ends of first combining portion are respectively connected to the first end portion and the third end portion, to interconnect the first radiating portion and the second radiating portion.

9. The antenna structure of claim 7, further comprises a second combining portion and a third combining portion; two opposite ends of the second combining portion are respectively connected to the third end portion and the fifth end portion; and two opposite ends of the third combining portion are respectively connected to the fourth end portion and the sixth end portion, the second radiating portion and the third radiating portion are interconnected by the second combining portion and the third combing portion.

10. An antenna structure, comprising:
an antenna, the antenna comprising:
a main radiating body,
a ground end and a feed end, and the ground end and the feed end extended from the main radiating body; and
a radiation blocking member positioned at one side of the antenna, to weaken electromagnetic field intensity of the antenna, and the radiation blocking member comprises:
a first curved portion; and
a second curved portion perpendicularly connected to the first curved portion.

11. The antenna structure of claim 10, wherein the main radiating body comprises a first radiating portion, a second radiating portion, and a third radiating portion interconnected together, the first radiating portion defining an opening.

12. The antenna structure of claim 11, wherein the radiation blocking member comprises the first curved portion aligned with the opening and is coplanar with the first radiating portion; and the second curved portion is coplanar with the ground end and the feed end and is parallel to the ground end and the feed end.

13. The antenna structure of claim 11, wherein the first radiating portion is substantially U-shaped and comprises a first end portion, a opposite second end portion, a first connecting portion; and two opposite ends of the first connecting portion are respectively connected the first end portion and the second end portion, the first end portion, the first connecting portion, and the second end portion define the opening.

14. The antenna structure of claim 13, wherein the second radiating portion is positioned at one side of the first radiating portion and forms a first slot with the first radiating portion.

15. The antenna structure of claim 14, wherein the second radiating portion substantially U-shaped and comprises a third end portion, a fourth end portion, and a second connecting portion; two opposite ends of the second connecting portion are respectively connected the third end portion and the fourth end portion; and the first slot is substantially U-shaped.

16. The antenna structure of claim 15, wherein the third radiating portion is positioned at one side of the second radiating portion and forms a second slot with the second radiating portion.

17. The antenna structure of claim 16, wherein the third radiating portion substantially U-shaped and comprises a fifth end portion, a sixth end portion, and a third connecting portion; and two opposite ends of the third connecting portion are respectively connected the fifth end portion and the sixth end portion, and the second slot is substantially U-shaped.

18. The antenna structure of claim 15, further comprises a first combining portion, two opposite ends of first combining portion are respectively connected to the first end portion and the third end portion, to interconnect the first radiating portion and the second radiating portion.

19. The antenna structure of claim 18, further comprise a second combining portion and a third combining portion; two opposite ends of the second combining portion are respectively connected to the third end portion and the fifth end portion, and two opposite ends of the third combining portion are respectively connected to the fourth end portion and the sixth end portion, and the second radiating portion and the third radiating portion are interconnected by the second combining portion and the third combing portion.
